(19) United States
(12) Patent Application Publication
(10) Pub. No.: US 2009/0093921 A1
(43) Pub. Date: Apr. 9, 2009

(54) METHOD FOR OPERATING A HYBRID VEHICLE

(76) Inventor: Jens-Werner Falkenstein, Aalen (DE)

Correspondence Address: KENYON & KENYON LLP, ONE BROADWAY, NEW YORK, NY, 10004, US

(21) Appl. No.: 12/158,442

(22) PCT Filed: Nov. 30, 2006
(86) PCT No.: PCT/EP2006/069137

§ 371 Date: Oct. 28, 2008

(30) Foreign Application Priority Data
Dec. 22, 2005 (DE) 10 2005 061 397.7

(51) Int. Cl. B60W 10/04; G06F 17/00; B60W 20/00

(52) U.S. Cl. 701/22; 180/65.275

(57) ABSTRACT

A method for operating a hybrid drive, in which at least two power units cooperate in driving, and an energy store of one of the power units is charged intermittently and one of the power units is at least intermittently supplied with driving energy from the energy store, the power unit generating a setpoint output. A requested setpoint drive torque of the drive is generated and the setpoint output of the power unit is simultaneously maintained on average over time, deviations from the setpoint output as a function of instantaneous operating points of the power units being permitted. This is done to optimize the fuel consumption.

### FIELD OF THE INVENTION

The present invention is based on a method for operating a hybrid vehicle.

### BACKGROUND INFORMATION

In recent years, the reduction of emissions and fuel consumption has led to the further development of hybrid drives for motor vehicles. The aim is to operate the combustion engine within ranges of advantageous efficiency factors, to switch the vehicle off when the vehicle is at a standstill or at low vehicle speeds, and to drive electrically and utilize braking energy by recuperation. This is accomplished by specifying optimal values for the degrees of freedom available in the drive train. Degrees of freedom in parallel hybrids are, for instance, the distribution of the driver-requested setpoint drive torque to the combustion engine and one or several electro machine(s), as well as the gear selection in automated multi-speed gearboxes. Over all, an optimization problem arises, the goal being low fuel consumption, low exhaust emissions, high driving enjoyment etc.

European Patent No. EP 1 136 311 A2 describes a hybrid vehicle in which a setpoint charge state of a battery is set as a function of whether the battery is expected to be charged or discharged during the vehicle operation. If it can be foreseen that the hybrid vehicle will stop in the near future and be restarted again or heavily accelerated so that a considerable discharging of the battery is to be expected, the setpoint charge state of the battery will be increased. If it is foreseeable that a braking operation of the hybrid vehicle is imminent, the setpoint charge state of the battery will be lowered so that the electric power produced during the braking operation by the generator-driven operation of the electro machine can be stored in the battery.

### SUMMARY

In parallel hybrids, an optimal distribution of the drive torque to the power units, in particular a combustion engine and an electro machine, is advantageously able to be found. In addition, the power requirement of a vehicle electrical system can be satisfied, and it is possible to ensure that the charge state of an electric energy store remains within a permitted range. For example, an electrical setpoint output for the electro machine is able to be determined based on the instantaneous power requirement of the vehicle electrical system and the instantaneous charge state. To specify the electric setpoint output when selecting the operating point of the electro machine may make little sense since the consideration of the instantaneous rotational speed of the electro machine directly results in the torque of the electro machine. The degree of freedom provided in hybrid operation (combustion engine and electro machine are in operation), the distribution of the setpoint drive torque to the two power units combustion of engine and electro machine, would thereby already be stipulated. Instead, a deviation from the electric setpoint output is useful, for instance by charging more heavily when an advantageous “energy price” is available. This energy price may be derived from, for example, the fuel quantity required to generate electric energy, and the generated electrical energy quantity. The energy price depends on the instantaneous operating point of the drive train or the instantaneous driving condition. If the energy price is not advantageous, then the energy store may be charged to a lesser degree or even discharged. The electric setpoint output must be satisfied as an average in time, but not at every instant. A corresponding method may also be used with other hybrid embodiments, such as with the power-splitting hybrid vehicles. The energy store preferably is an electric energy store. However, any other type of energy store, such as a flywheel, for example, is possible as well.

If the driving cycle is known in advance, then a trajectory optimization may be used to determine optimal operating points of the power units. In the standard case, only the past part is known during a driving cycle, but not the one lying in the future.

An optimal selection of the power-unit operating points of combustion engine and one electro motor (or more) in the case of hybrid vehicles is made, the setpoint drive torque requested by the driver and by auxiliary power units, such as the air-conditioner compressor, being generated, and an electric setpoint output being maintained on average over time, although momentary deviations from the electric setpoint output may take place, depending on the momentary energy price.

This may be accomplished by optimizing the operating points of the power units on the basis of the current marginal conditions, such as the vehicle velocity, for example, and the setpoint drive torque requested by the driver or auxiliary power units; the summed or integrated deviation of the actual electric output from the electric setpoint output over a previous time interval is taken into account in the optimization in addition. If, for example, insufficient electric energy was generated in the examined time period, then a performance index for what is known as an online optimization (an optimization while the algorithms of the vehicle control unit are running) is modified in such a way that a higher electric output tends to result.

Another advantageous possibility consists of what is referred to as an offline optimization, i.e., the optimization method is solved for various sets of marginal conditions (e.g., vehicle velocity and setpoint drive torque), and the results are stored in the vehicle control device in the form of characteristics maps. In this case it is possible to modify the results stored with the aid of characteristics maps on the basis of the integrated deviation in order to adjust the actual electric output.

Another possibility consists of storing several sets of characteristics maps, which differ in the valuation of the electric output in the performance index of the offline optimization and thus lead to a different actual output on average. The selection as to which set of characteristics maps is utilized is then made on the basis of the integrated deviation. An interpolation between the outputs of the individual sets of characteristics maps based on the deviation is possible as well.

It may be advantageous if the influence of the summed or integrated deviation on the actual electric output of the electro machine(s) is able to be selected to be of different magnitude, for example by specifying an amplification factor. If the charge state of the energy store is very high or very low, or if critical operating states of the energy store are present, e.g., a high temperature, it is possible to ensure that the actual electric output lies close to the setpoint output. Given an appropriate specification of the setpoint output, the energy store will not be stressed and is brought into a state of medium charge. If the charge state or the operating state of the electric energy store improves, then the effect of the integrated deviation on the actual electric output may be canceled again, as a result of which the actual electric output once again deviates more heavily from the setpoint output depending on the momentary energy price, although the setpoint output is maintained on average over time.

The present invention may be used in all hybrid vehicle drives in which degrees of freedom are provided, such as the distribution of the torque requested by the driver or auxiliary components among the combustion engine and one electro machine or more.

### BRIEF DESCRIPTION OF THE DRAWINGS

Additional specific embodiments, aspects and advantages of the present invention also derive, without limiting the universality, from an exemplary embodiment of the present invention presented below with reference to drawing.

FIG. 1 shows a preferred control strategy of a hybrid drive.

FIG. 2 shows a characteristic of a maximum torque as a function of an angular velocity of an electro machine and a combustion engine.

FIG. 3 shows a time-dependent behavior of a torque and an electric output in a jump between two operating points.

### DETAILED DESCRIPTION OF EXAMPLE EMBODIMENTS

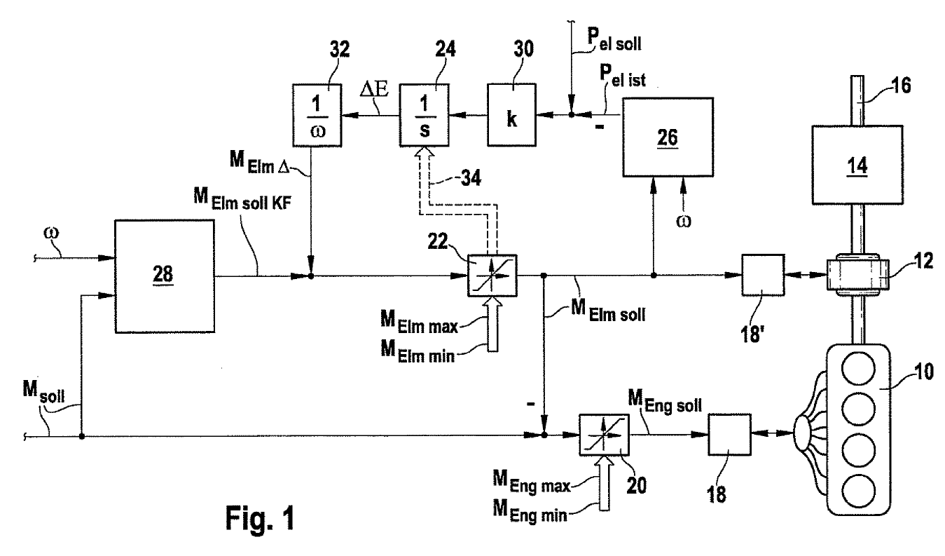

An exemplary embodiment of the present invention is represented in FIGS. 1 through 3. By way of example, a combustion engine 10 is provided with a manifold injection system and an electronic accelerator pedal (e-accelerator, electronic throttle valve). A flywheel of combustion engine 10 is coupled to an electro machine 12 without interposed interruption clutch (crankshaft starter generator), so that electric-only driving is not an option. The torques of combustion engine 10 and electro machine 12 are summed to form the drive torque, which is transmitted to driven wheels via a manual transmission 12 having stepped drive ratios, and a shaft 16 (not shown), as can be gathered from FIG. 1. A control device 18 is provided for combustion engine 10, and a control device 18′ is provided for electro machine 12.

A gear engaged by the driver cannot be influenced by a control device. The driver specifies the setpoint drive torque Msoll, i.e., the cumulative torque of combustion engine 10 and electro machine 12, at the transmission input. The joint angular velocity ω of combustion engine 10 and electro machine 12 results from the vehicle velocity and the gear that is engaged. In an offline optimization, a characteristics map (block 28) was calculated, which determines a first setpoint torque MElmsollKF for electro machine 12 based on angular velocity ω and setpoint drive torque Msoll. The difference from Msoll and a second, corrected setpoint torque MElmsoll for electro machine 12 corresponds to setpoint torque MEngsoll for combustion engine 10. The efficiency characteristics maps of combustion engine 10 and electro machine 12 as well as an energy store (not shown) are taken into account in the offline optimization. Setpoint torque MElmsollKF or the characteristics map is selected such that electro machine 12 generates more electric energy in operating points having an advantageous energy price, and correspondingly less when energy prices are high. In addition, electro machine 12 is used to reduce exhaust gas emissions by shifting the operating point of combustion engine 10.

Depending on the operating point or the marginal conditions (Msoll, ω), electro machine 12 generates a higher or lower actual electric output Pelist, or it transitions from generator-driven to engine-driven operation. The characteristics map is selected such that the actual electric output Pelist approximately satisfies the average power requirement of the vehicle electric system (not shown) on average (across all operating points Msoll, ω). To this end, a frequency distribution across the operating points (Msoll, ω) as it arises in a typical driving cycle is assumed. Since individual driving cycles vary and also the power requirement of the vehicle electrical system, the characteristics map output is corrected. This is done on the basis of an integrated deviation ΔE of the actual electric output Pelist from the electric setpoint output Pelsoll. Electric setpoint output Pelsoll is determined with the aid of the power requirement of the vehicle electric system and on the basis of the charge state (SOC) of the electric energy store (not shown). In addition, further variables such as the temperature, etc. may be taken into account.

In the exemplary embodiment, actual electric output Pelist is calculated with the aid of a simple model 26 of electro machine 12—generally consisting of the efficiency characteristics map. It is assumed that electro machine 12 implements a setpoint torque MElmsoll with sufficient accuracy. As an alternative, actual electric output Pelist may also be determined from measured variables.

Deviation ΔE results as output of an integrator 24, which integrates the difference between the electric setpoint output Pelsoll and actual electric output Pelist. An additional correction torque ME1mΔ is calculated, which corresponds to the quotient from the deviation ΔE and the instantaneous angular velocity ω (block 32). As an option, the efficiency of electro machine 12 may be taken into account as well in this context. With the aid of an amplification factor k (block 30) the effect of the feedback loop is influenced. If amplification factor k is increased, the deviation of actual electric output Pelist from electric setpoint output Pelsoll becomes smaller. In particular with very high or very low charge states (SOC) of electric energy store 12, or given critical operating parameters of the electric energy store (e.g., excess temperature), it is advisable to maintain electric setpoint output Pelsoll with sufficient accuracy by increasing amplification factor k.

Given a dynamic driving style with operating points that vary considerably, the described method ensures that the actual electric output Pelist is optimally selected depending on the energy price, influenced by the characteristics map output. In dynamically changing operating points, there are only slight changes in the feedback or deviation ΔE due to the integrator behavior. Deviation ΔE comes about in such a way that electric setpoint output Pelsoll will not be satisfied at all times but on average over time.

In the case of more prolonged driving with an approximately constant operating point (Msoll, ω), such as highway driving, actual electric output Pelist approximates setpoint output Pelsoll asymptotically due to correction torque MelmΔ, based on deviation ΔE.

Setpoint torque MElmsoll of the electro machine is limited with the aid of a limiter 22. Limits MElmmax, MElmmin are calculated from the instantaneous operating limits of electro machine 12 and the electric energy store as well as from the instantaneous power requirement of the vehicle electrical system. Limits MElmmax, MElmmin may depend upon additional marginal conditions, e.g., angular velocity ω and setpoint drive torque Msoll. If a limitation is active, then the integration of deviation ΔE is frozen or controlled, e.g., by unilateral limiting (“anti-windup”, line 34).

It is also advantageous to limit deviation ΔE as a function of the operating state of the drive train, or to newly initialize it when a change of the operating state occurs, e.g., in the transition from the brake-energy recuperation to hybrid driving, or in the transition to boost operation.

Setpoint torque MEngsoll for combustion engine 10 is limited to operating limits MEngmax, MEngmin of combustion engine 10 with the aid of a limiter 20. The illustrated method may therefore also be used for a limiting control during boost operation. The behavior of the limiting control is adjustable via amplification factor k in that, for example, amplification factor k is influenced by the instantaneous charge state (SOC) of the electric energy store.

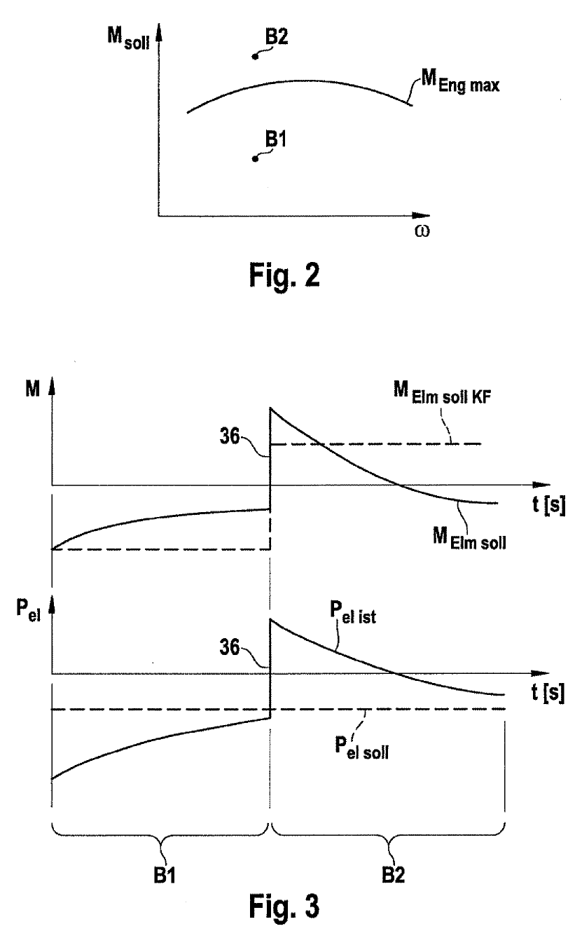

FIGS. 2 and 3 elucidate an idealized jump in an operating point 36 in which Msoll changes abruptly. For the sake of simplicity, a constant angular velocity ω is assumed, so that the jump has no effect on ω. A corresponding operating-point change is roughly produced when the driver suddenly requests a higher torque Msoll, for instance in order to keep the vehicle speed constant in the transition from a level roadway (operating point B1) to an incline (operating point B2) without changing gears. In operating point B1, a setpoint torque Msoll is required that lies below maximum torque MEngmax of combustion engine 10 (FIG. 2). In the process, the characteristics map (block 28) supplies a negative MElmsollKF, in conjunction with an increased generation of electric energy (negative Pelist), by which an energetically meaningful load increase of combustion engine 10 is achieved (FIG. 2). Operating point B1 is maintained for a longer period of time; because of the influence of correction torque MElmΔ, actual electric output Pelist asymptotically approaches setpoint output Pelsoll (FIG. 3).

In operating point B2, a setpoint torque Msoll that lies above maximum torque MEngmax of combustion engine 10 (FIG. 2) is required; this setpoint torque Msoll may be set temporarily in that electro machine 12 changes over to engine-driven operation and withdraws power from the electric energy store (boost operation, MElmsollKF and Pelist are positive). Operating point B2 is requested by the driver for a longer period of time, correction torque MElmΔ leading to a reduction in setpoint torque MElmsoll and an approximation of actual electric output Pelist to setpoint output Pelsoll, in conjunction with a reduction of the generated cumulative torque of combustion engine 10 and electro machine 12. This leads to a limiting control of the boost operation.

Integrated deviation ΔE may be considered a measure for the energy quantity withdrawn from the energy store during boost operation. If the driver reduces setpoint torque Msoll, the “storage effect” of ΔE or MElmΔ initially causes a higher charge power to be requested in order to at least partially compensate for the energy loss of the electric energy store during boost operation.

1-13. (canceled)

14. A method for operating a hybrid drive, the hybrid drive including at least two power units which cooperate in driving, an energy store being charged at least intermittently by one of the power units and one of the power units is at least intermittently supplied with driving energy from the energy store, the power unit generating a setpoint output, the method comprising:
generating a requested setpoint drive torque of the drive; and
permitting deviations from the setpoint output as a function of instantaneous operating points of the power units while simultaneously maintaining the setpoint output of the power unit over time.

15. The method as recited in claim 14, further comprising:
optimizing the operating points of the power units as a function of instantaneous marginal conditions and as a function of the requested setpoint drive torque.

16. The method as recited in claim 15, wherein the optimizing includes taking into account a deviation of actual output, summed or integrated over a past time period, from the setpoint output of the power unit.

17. The method as recited in claim 16, wherein the energy store is charged more heavily if the charging results in an optimum of the operating points of the power units.

18. The method as recited in claim 17, wherein the optimization takes place during a period when algorithms of a vehicle control device are running.

19. The method as recited in claim 15, wherein results for different sets of marginal conditions are stored in characteristics maps in a vehicle control device for the optimization.

20. The method as recited in claim 19, wherein the results stored are modified based on a deviation of an actual output, summed or integrated over a past time period, from the setpoint output of the power unit.

21. The method as recited in claim 17, wherein multiple sets of characteristics maps are stored, which, on average, lead to different actual outputs of the power unit.

22. The method as recited in claim 21, wherein a selection of the set of characteristics maps is made based on a deviation of the actual output, summed or integrated over a past time period, from the setpoint output of the power unit.

23. The method as recited in claim 22, wherein an interpolation takes place between outputs of the individual sets of characteristics maps.

24. The method as recited in claim 15, wherein a deviation of an actual output, summed or integrated over a past time period, from the setpoint output of the power unit is weighted by specifying an amplification factor.

25. The method as recited in claim 24, wherein the deviation of the actual output, summed or integrated over a past period, from the setpoint output of the power unit is limited as a function of the operating state of the drive train.

26. The method as recited in claim 25, wherein the deviation of the actual output, summed or integrated over a past time period, from the setpoint output of the power unit is newly initialized in a change from one operating state of the drive train to another one.
